(19) United States
(12) Patent Application Publication
(10) Pub. No.: US 2024/0208217 A1
(43) Pub. Date: Jun. 27, 2024

(54) LIQUID EJECTION HEAD AND LIQUID EJECTION APPARATUS

(71) Applicant: CANON KABUSHIKI KAISHA, Tokyo (JP)

(72) Inventors: YASUHIKO OSAKI, Kanagawa (JP); TAKUYA IWANO, Tokyo (JP); YUMI KOMAMIYA, Kanagawa (JP); TAKAHITO KIDO, Kanagawa (JP); MOTOHIRO OGAWA, Kanagawa (JP); JOS HOLLANDS, Baarlo (NL); DICK BOERSTAL, Velden (NL)

(21) Appl. No.: 18/390,968

(22) Filed: Dec. 20, 2023

(30) Foreign Application Priority Data
Dec. 23, 2022 (JP) 2022-207546

(51) Int. Cl. B41J 2/14; B41J 2/045; B41J 29/377

(52) U.S. Cl. CPC B41J 2/1408; B41J 2/04541; B41J 2/0458; B41J 2/04581; B41J 29/377

(57) ABSTRACT

A liquid ejection head includes: a liquid ejection unit including an ejection element substrate including multiple ejection elements, a first wiring substrate and a second wiring substrate connected with the ejection element substrate and arranged to face each other so as to sandwich the ejection element substrate from a facing direction, a first driving element provided on the first wiring substrate to drive the ejection elements, a second driving element provided on the second wiring substrate to drive the ejection elements, a first cooling member cooling down the first driving element, and a second cooling member cooling down the second driving element. Additionally, in the facing direction, the first cooling member, the first driving element, the second driving element, and the second cooling member are arranged in this order.

### BACKGROUND OF THE INVENTION

### Field of the Invention

The present disclosure relates to a liquid ejection head and a liquid ejection apparatus.

### Description of the Related Art

There has been demanded high-speed printing in liquid ejection apparatuses for the use of professionals such as business use, commercial use, or industrial use. In order to implement the high-speed printing, a liquid ejection head that includes multiple ejection modules on board with a great ejection width of one pass has been proposed. In some cases, a driving element to drive an ejection element is on board each ejection module of the above-described liquid ejection head. In the implementation of the high-speed printing, heat from the driving element is a problem. Japanese Patent Laid-Open No. 2010-105377 describes a technique of dissipating the heat from the driving element by attaching a heatsink, which cools down the driving element held by a substrate, to be put in contact with the driving element.

In order to implement the efficient cooling, a reduction of a thermal resistance between the driving element and a cooling member is required, and in order to reduce the thermal resistance, the driving element and the cooling member are required to be closely put in contact with each other reliably. On the other hand, in a case where the number of the ejection elements is increased to implement the high-speed printing, the size of each driving element is increased, or the number of the driving elements is increased. In a case where the size of each driving element is increased, or the number of the driving elements is increased in the method of Japanese Patent Laid-Open No. 2010-105377, there is a possibility that the cooling member cannot be closely fixed properly. Additionally, in a case where a flexible wiring substrate, which is flexible and has a high degree of freedom of the layout, as the substrate including the driving element on board, a support member and the like to closely fix the cooling member and the driving element to each other is required, and there is a possibility of causing an increase in the size of the head.

### SUMMARY OF THE INVENTION

A liquid ejection head according to an aspect of the present disclosure includes: a liquid ejection unit including an ejection element substrate in which multiple ejection ports configured to eject a liquid are arrayed in an array direction and including multiple ejection elements configured to generate energy to eject the liquid from the ejection ports, a first wiring substrate and a second wiring substrate connected with the ejection element substrate and arranged to face each other so as to sandwich the ejection element substrate from a facing direction substantially orthogonal to the array direction, a first driving element provided on the first wiring substrate and configured to drive the ejection elements, a second driving element provided on the second wiring substrate and configured to drive the ejection elements, a first cooling member configured to cool down the first driving element, and a second cooling member configured to cool down the second driving element, in which in the facing direction, the first cooling member, the first driving element, the second driving element, and the second cooling member are arranged in this order.

Further features of the present invention will become apparent from the following description of exemplary embodiments with reference to the attached drawings.

### BRIEF DESCRIPTION OF THE DRAWINGS

FIG. 1 is a schematic view illustrating an example of a liquid ejection apparatus;

FIG. 2 is a perspective view of a liquid ejection head;

FIG. 3 is a perspective view of the liquid ejection head;

FIG. 4 is an exploded perspective view of the liquid ejection head;

FIG. 5 is an electric connection configuration diagram of the liquid ejection head;

FIG. 6 is a perspective view of a liquid ejection unit;

FIG. 7 is a perspective view of the liquid ejection unit;

FIG. 8 is an exploded perspective view of the liquid ejection unit;

FIG. 9 is an enlarged view of an electrode unit of the liquid ejection unit;

FIG. 10 is a perspective view of a support unit;

FIG. 11 is a plan view of the liquid ejection head assembled on the support unit that is viewed from an ejection surface side;

FIG. 12 is a cross-sectional view taken along XII-XII in FIG. 11;

FIG. 13 is a cross-sectional view taken along XIII-XIII in FIG. 11;

FIG. 14 is a cross-sectional view taken along XIV-XIV in FIG. 11;

FIGS. 15A and 15B are diagrams illustrating a liquid member connection configuration between the support unit and a liquid supply unit;

FIG. 16 is a cross-sectional view of a fluid connection unit between the liquid supply unit and a liquid supply member;

FIG. 17 is a diagram illustrating a liquid member connection configuration of the support unit;

FIG. 18 is a diagram illustrating a liquid member connection configuration of the liquid ejection unit;

FIG. 19 is a diagram illustrating a fluid connection configuration in an ejection element substrate;

FIG. 20 is a perspective view of a cooling unit;

FIG. 21 is an exploded view of the cooling unit;

FIG. 22 is a cross-sectional view taken along XXII-XXII in FIG. 20;

FIGS. 23A and 23B are cross-sectional views of an electric connection unit between a liquid ejection apparatus main body and the liquid ejection head;

FIG. 24 is an exploded view of the cooling unit; and

FIG. 25 is a cross-sectional view of the cooling unit.

### DESCRIPTION OF THE EMBODIMENTS

Examples of embodiments of the present disclosure are described below with reference to the drawings. Note that, the descriptions below are not intended to limit the scope of the present disclosure. For instance, although a method of ejecting a liquid by driving a piezoelectric element is described as an example in the present embodiment, a liquid ejection head employing a thermal method by which the liquid is ejected by an air bubble generated by a heater element and other various liquid ejection methods are also within the scope of application of the present disclosure. That is, the liquid ejection head may be a head including an arbitrary energy generation element that is formed to generate energy to eject the liquid.

The present embodiment may be an ink jet printing apparatus (a printing apparatus) in a mode of circulating the liquid such as ink between a tank and the liquid ejection head; however, another mode may be applicable. For example, a mode in which the ink is not circulated, and tanks are provided upstream and downstream the liquid ejection head, respectively, to flow the ink from one tank to the other tank so as to flow the ink in a pressure chamber may be applicable. Additionally, the apparatus according to the present disclosure is not limited to the printing apparatus that ejects the ink and may be a liquid ejection apparatus that ejects an arbitrary liquid.

### First Embodiment

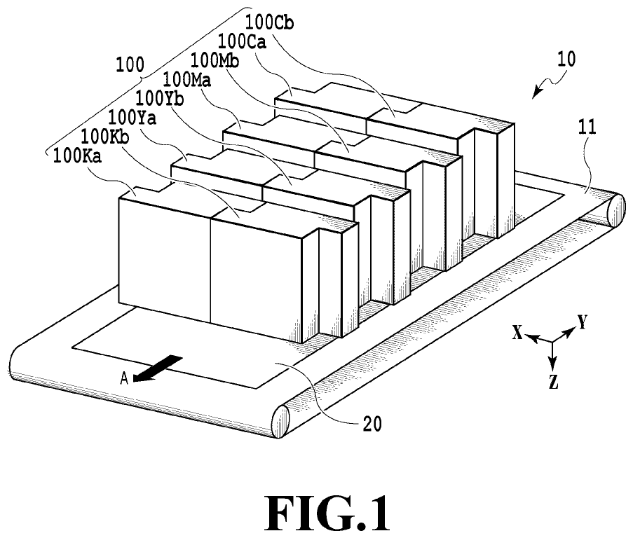

FIG. 1 is a schematic view illustrating an example of a liquid ejection apparatus 10 of the present embodiment. The liquid ejection apparatus 10 includes a liquid ejection head 100, which is a so-called one-pass type that completes printing of an image of a predetermined region by moving a printing medium 20 once in a case of printing the image in the predetermined region of the printing medium 20. Ejection ports are arrayed in the liquid ejection head 100 over a range corresponding to an entire width (an X direction in FIG. 1) of the printing medium 20. The printing medium 20 is conveyed by a conveyance unit 11 in a direction of an arrow A, and printing is thus performed by the liquid ejection head 100. The liquid ejection head 100 of the present embodiment is the liquid ejection head 100 corresponding to four colors in total, which are cyan, magenta, yellow, and black. In more detail, two heads are provided for each color. Specifically, cyan heads 100Ca and 100Cb, magenta heads 100Ma and 100Mb, yellow heads 100Ya and 100Yb, and black heads 100Ka and 100Kb are provided. Hereinafter, one of those eight heads is focused and described. Additionally, for the sake of simplifying the description, an arbitrary one of the heads is described as the liquid ejection head 100. Note that, the liquid ejection head of the present disclosure may be a head in an arbitrary mode and is not limited to the example illustrated in FIG. 1.

Moreover, in the present embodiment, a direction of ejecting the liquid (a direction of gravity) is described as a +Z direction, an upstream side in the conveyance direction of the printing medium 20 is described as a +Y direction, an array direction in which the ejection ports are arrayed in the head is described as a +X direction.

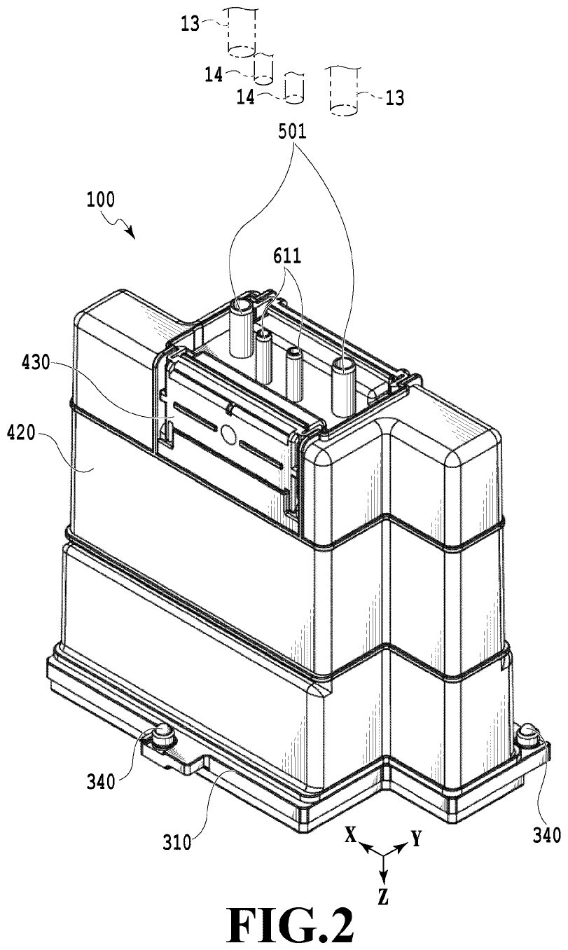

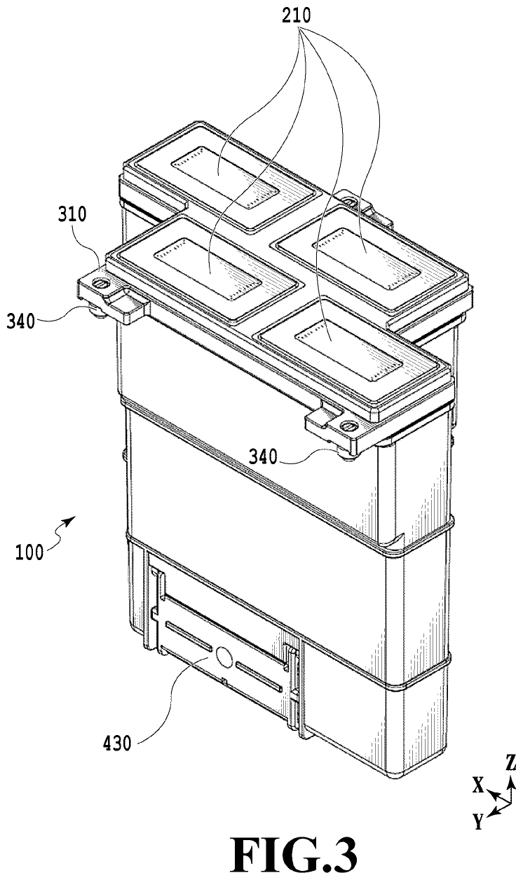

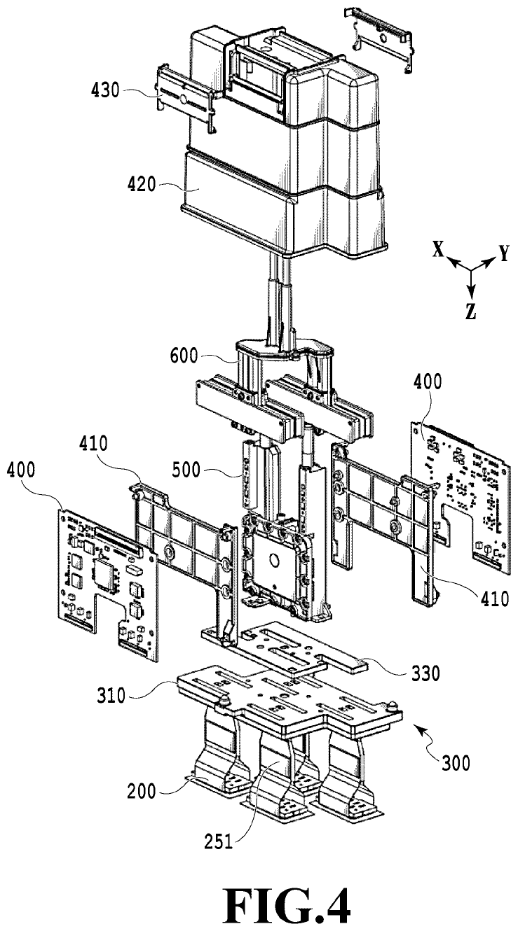

FIG. 2 is a perspective view of the liquid ejection head 100 of the present embodiment. FIG. 3 is a perspective view of the liquid ejection head 100 of the present embodiment that is viewed from a different direction from that in FIG. 2. FIG. 4 is an exploded perspective view of the liquid ejection head 100 of the present embodiment. A configuration of the liquid ejection head 100 is described with reference to FIGS. 2 to 4. As described above, hereinafter, one of the eight heads illustrated in FIG. 1 is described as the liquid ejection head 100.

As illustrated in FIG. 3, the liquid ejection head 100 is a head in which four ejection element substrates 210, which can eject the liquid, are arrayed in a staggered pattern on a support member 310. The liquid ejection head 100 is positioned by a reference member 340 on a main body of the liquid ejection apparatus. As illustrated in FIG. 2, a liquid connection unit 501 and a refrigerant connection unit 611 are provided on the top of the liquid ejection head 100. The liquid connection unit 501 is connected to a liquid supply unit 13 on a liquid ejection apparatus main body side, and the refrigerant connection unit 611 is connected with a refrigerant supply unit 14 on the liquid ejection apparatus main body side. Thus, the liquid such as ink and a refrigerant are supplied into the liquid ejection head 100 from the liquid ejection apparatus main body.

A cover member 420 and an electric connection unit cover member 430 to cover an electric substrate, an electric connection unit, and the like for protection are provided to an exterior portion of the liquid ejection head 100. As illustrated in FIG. 4, the liquid ejection head 100 includes therein a support unit 300 including the support member 310, an electric wiring substrate 400, and an electric wiring substrate support member 410 holding the electric wiring substrate 400. Additionally, the liquid ejection head 100 includes a liquid supply unit 500 that supplies a liquid ejection unit 200 with the liquid through the support unit 300 and a cooling unit 600 that cools down a driving circuit. The liquid ejection head 100 includes multiple liquid ejection units 200, which are specifically four liquid ejection units 200. A configuration of each part of the liquid ejection head 100 is described below in detail.

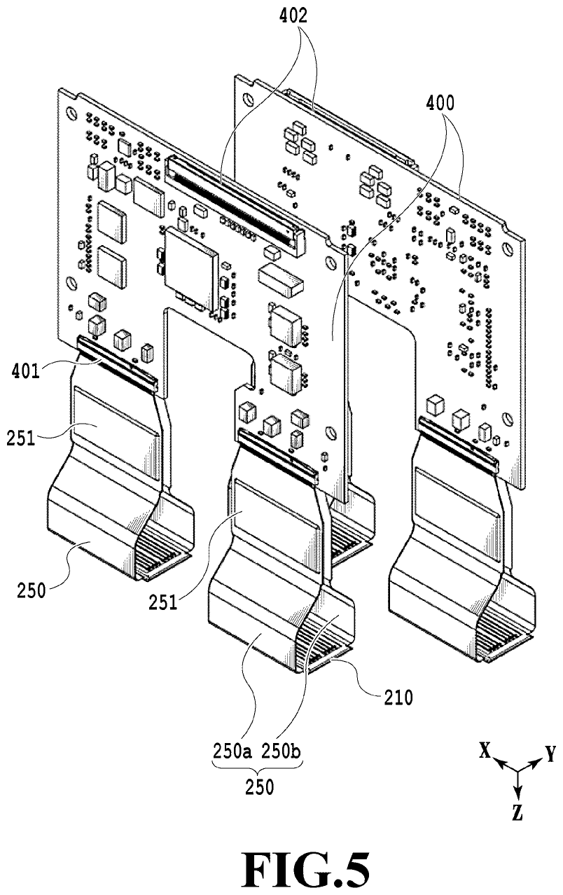

FIG. 5 is an electric connection configuration diagram of the liquid ejection head 100 of the present embodiment. The liquid ejection apparatus main body and the ejection element substrate 210 are electrically connected with each other through a flexible wiring substrate 250 and the electric wiring substrate 400. The electric wiring substrate 400 is electrically connected with a control unit (not illustrated) on the liquid ejection apparatus main body side by an electric connection terminal 402. The electric wiring substrate 400 is supplied with an ejection driving signal and power required for the ejection through the electric connection terminal 402. The electric wiring substrate 400 and the flexible wiring substrate 250 are electrically connected with each other by an electric connection unit 401. Wirings are concentrated by the electric circuit in the electric wiring substrate 400, and thus the terminal number of the electric connection terminals 402 can be less than the terminal number of the ejection element substrates 210. Therefore, there are a few number of the electric connection units that need to be detached in a case of assembling the liquid ejection head 100 on the liquid ejection apparatus or in a case of replacing the liquid ejection head 100. A driving circuit substrate 251 to drive the ejection element of the ejection element substrate 210 is provided on the flexible wiring substrate 250. The driving circuit substrate 251 includes a driving element to drive the ejection element. The ejection driving signal supplied to the electric wiring substrate 400 is inputted to the driving circuit substrate 251. The driving circuit substrate 251 performs driving control to drive each printing element according to the ejection driving signal. As illustrated in FIG. 5, in the present embodiment, one liquid ejection unit 200 includes two flexible wiring substrates 250, which are a first flexible wiring substrate 250a and a second flexible wiring substrate 250b. Note that, hereinafter, in a case where an individual flexible wiring substrate is described, the flexible wiring substrate is referred to as the first flexible wiring substrate 250a or the second flexible wiring substrate 250b, and in a case where a matter common to the two flexible wiring substrates is described, the two flexible wiring substrates are simply described as the flexible wiring substrate 250. Additionally, the driving circuit substrate 251 provided on the first flexible wiring substrate 250a is referred to as a first driving circuit substrate 251a including a first driving element. The driving circuit substrate 251 provided on the second flexible wiring substrate 250b is referred to as a second driving circuit substrate 251b including a second driving element. Note that, hereinafter, in a case where an individual driving circuit substrate is described, the driving circuit substrate is referred to as the first driving circuit substrate 251a or the second driving circuit substrate 251b for the description, and in a case where a matter common to the two driving circuit substrates is described, the driving circuit substrates are simply described as the driving circuit substrate 251.

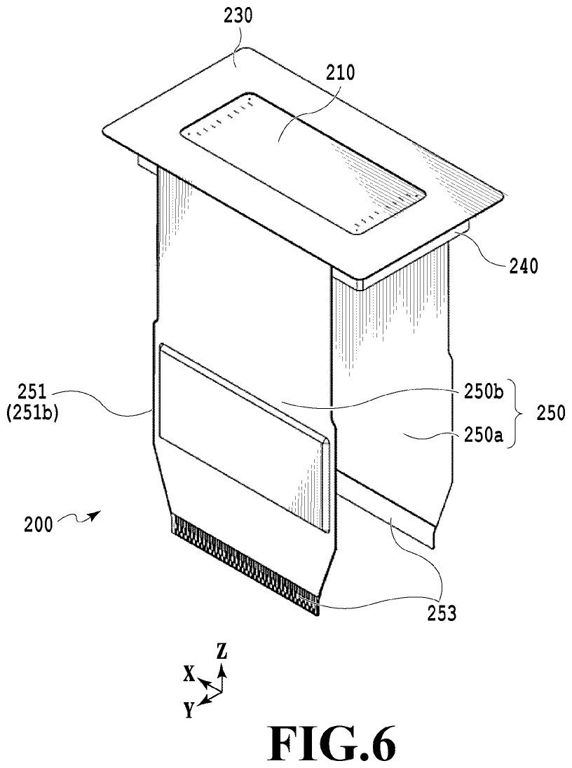

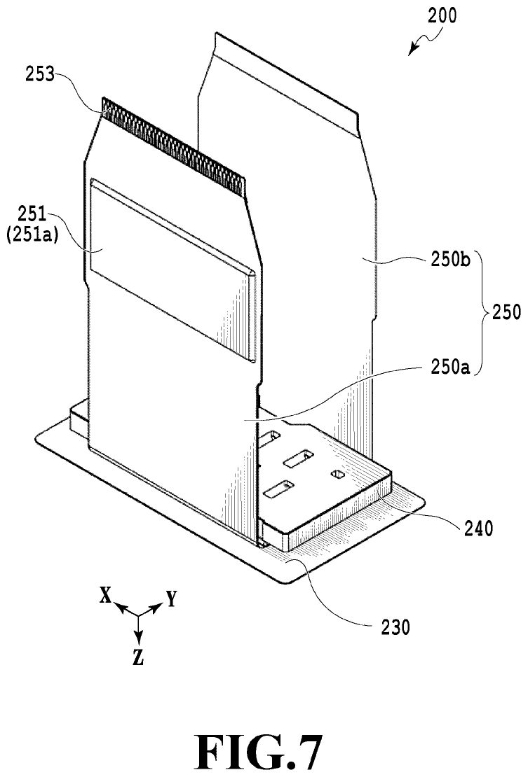

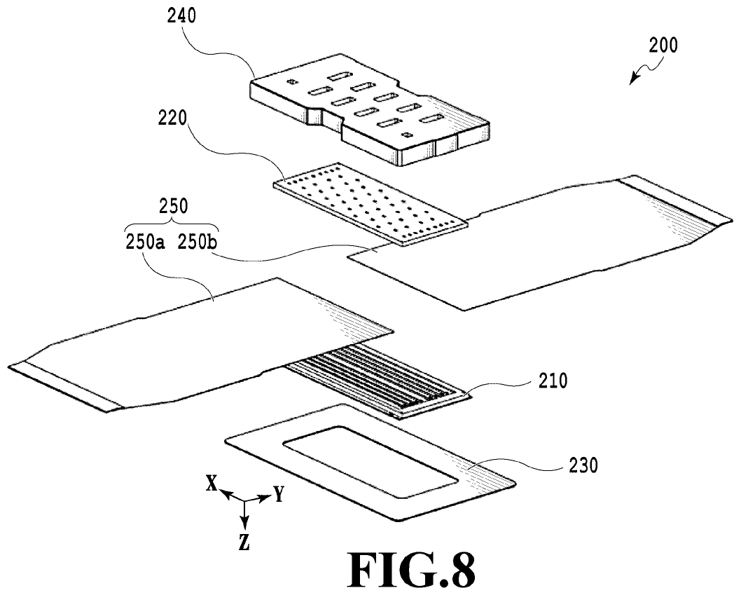

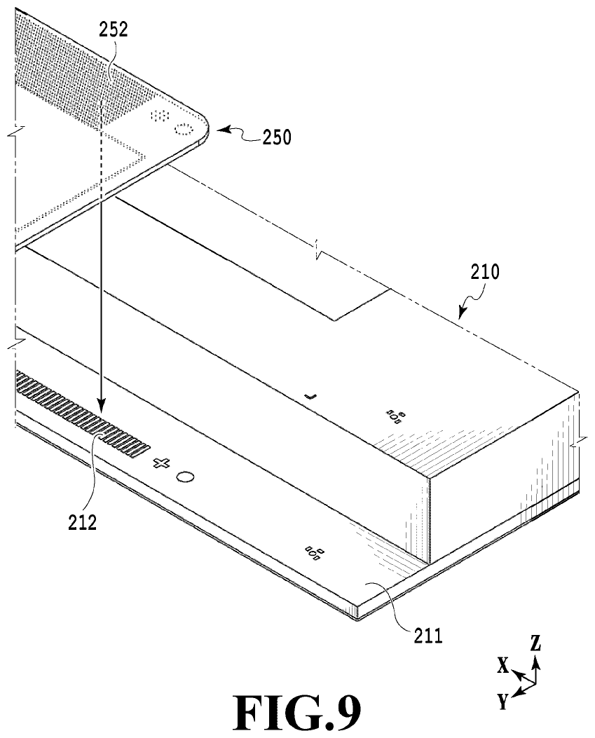

FIG. 6 is a perspective view of the liquid ejection unit 200. FIG. 7 is a perspective view of the liquid ejection unit 200. FIG. 8 is an exploded perspective view of the liquid ejection unit 200. FIG. 9 is an enlarged view of an electrode unit of the liquid ejection unit 200. A configuration of the liquid ejection unit 200 is described below with reference to FIGS. 6 to 9.

As illustrated in FIGS. 6 to 8, the liquid ejection unit 200 includes the ejection element substrate 210 that ejects the liquid, an ejection element substrate flow channel member 220 that supplies the ejection element substrate 210 with the liquid, and a flow channel member 240 that supplies the ejection element substrate flow channel member 220 with the liquid. Additionally, the liquid ejection unit 200 includes the flexible wiring substrate 250 electrically connected with the ejection element substrate 210 and an ejection element substrate support member 230 joined on an ejection surface side of the ejection element substrate 210.

As illustrated in FIG. 9, an electrode unit 212 is provided on a thin plate unit 211 at each of two end portions of the ejection element substrate 210. FIG. 9 is an enlarged view of one end portion of the ejection element substrate 210. Note that, this end portion is an end portion in a direction crossing an array direction in which the ejection elements (or the ejection ports) are arrayed on the ejection element substrate 210. As illustrated in FIG. 9, the ejection element substrate 210 and the flexible wiring substrate 250 are electrically connected with each other by putting electrodes of the electrode unit 212 and a first electric connection unit 252 of the flexible wiring substrate 250 with each other. As illustrated in FIGS. 6 to 8, in order to suppress entering of the liquid to this electric connection unit and reinforce the thin plate unit 211 of the ejection element substrate 210, the ejection element substrate support member 230 is joined on an ejection surface side of the thin plate unit 211. The driving circuit substrate 251 to drive the ejection element of the ejection element substrate 210 is provided on the flexible wiring substrate 250 (see FIG. 5). As illustrated in FIGS. 7 and 8, the first flexible wiring substrate 250a and the second flexible wiring substrate 250b are arranged to face each other so as to sandwich the ejection element substrate 210 from directions of the facing substantially orthogonal to the array direction in which the ejection elements are arrayed.

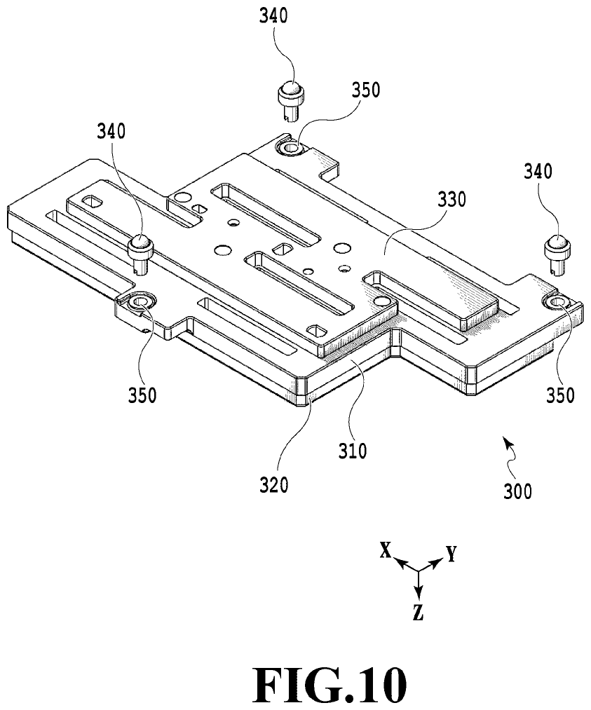

FIG. 10 is a perspective view of the support unit 300 that supports the liquid ejection unit 200. The support unit 300 includes the support member 310 onto which the liquid ejection unit 200 is joined and a frame body member 320 surrounding the liquid ejection unit 200. Additionally, the support unit 300 includes a liquid supply member 330 in which a flow channel that supplies each liquid ejection units 200 (in the present embodiment, the four liquid ejection units 200) with the liquid through the support member 310 is formed. Moreover, the support unit 300 includes the reference member 340 having a function of positioning between the liquid ejection head 100 and the liquid ejection apparatus main body and a reference fixation member 350 to fix the reference member 340 on the support member 310. It is preferable to select the same member for the support member 310, the frame body member 320, and the liquid supply member 330 in consideration of, for example, a thermal expansion effect in ink heating temperature adjustment or due to environmental variation. Otherwise, in a case where different types of members are used for the support member 310, the frame body member 320, and the liquid supply member 330, it is preferable to select members with a linear coefficient of expansion as close to each other as possible. Therefore, it is possible to suppress deformation of the whole support unit in the thermal expansion and accordingly a deterioration in a position accuracy of the ejection element substrate 210.

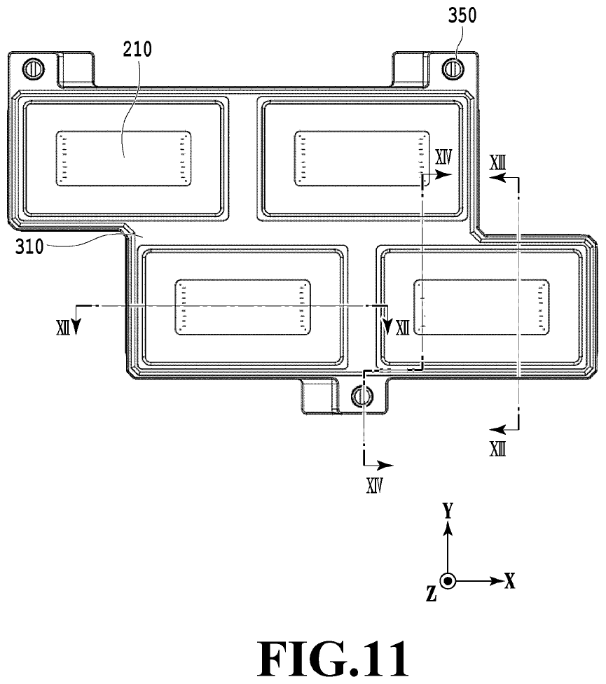

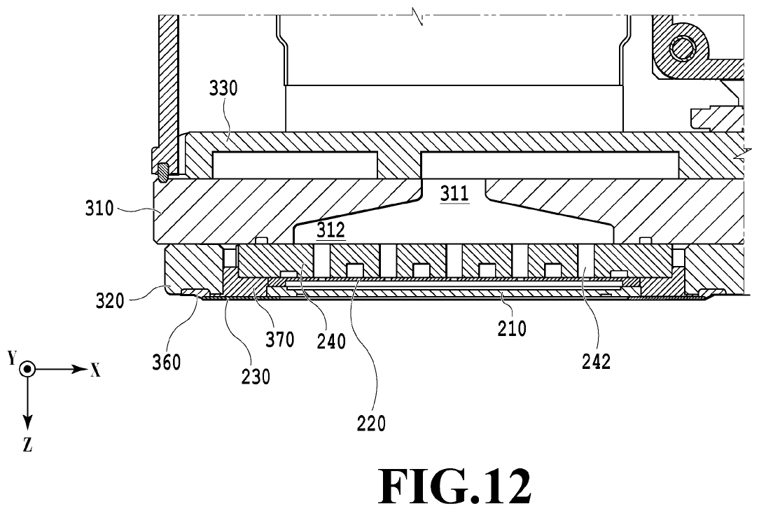

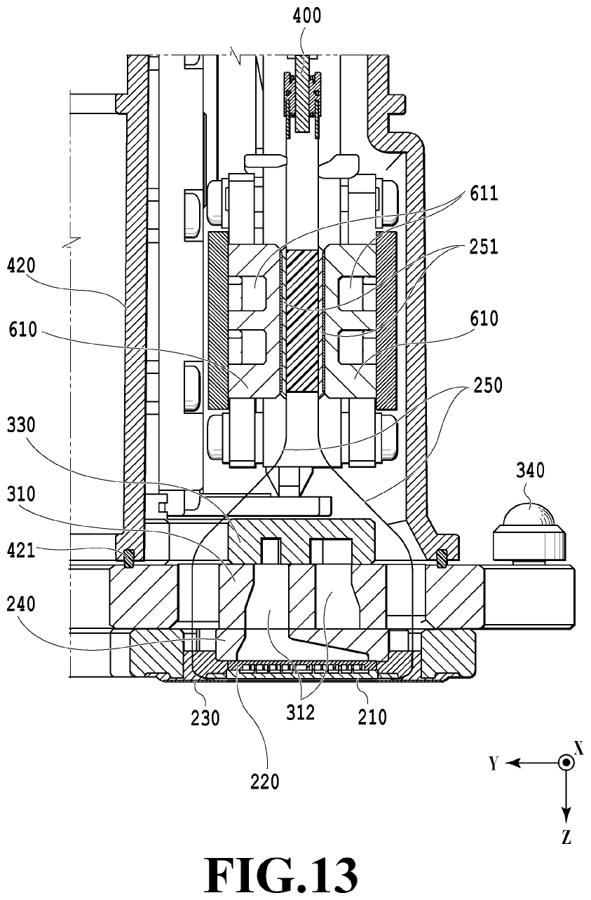

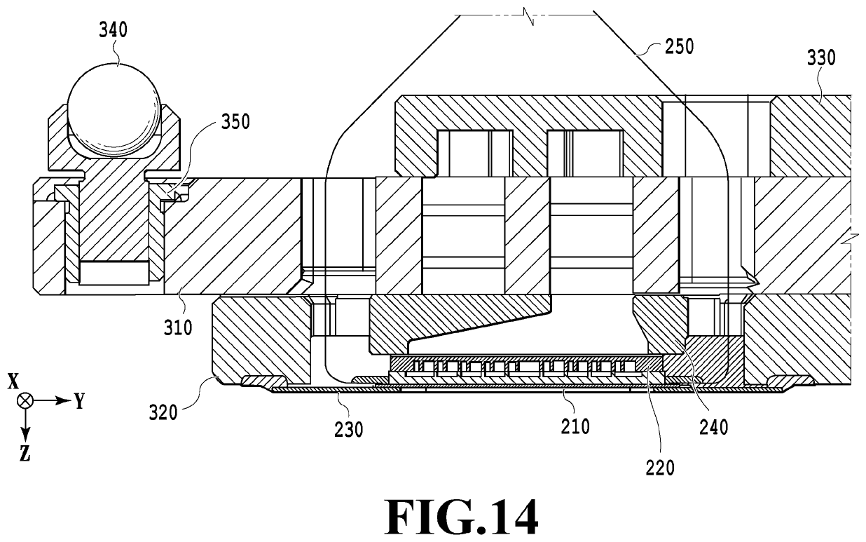

FIG. 11 is a plan view of the liquid ejection head in which the liquid ejection unit 200 is assembled on the support unit 300 that is viewed from the ejection surface side. FIG. 12 is a cross-sectional view taken along XII-XII in FIG. 11. FIG. 13 is a cross-sectional view taken along XIII-XIII in FIG. 11. FIG. 14 is a cross-sectional view taken along XIV-XIV in FIG. 11. Note that, FIG. 13 is a cross-sectional view taken along XIII-XIII in FIG. 11 in a state where the liquid ejection unit 200 is assembled on the support unit 300 and additionally each member is assembled. As illustrated in FIGS. 12 to 14, the flow channel member 240 and the liquid supply member 330 are joined to the support member 310, and liquid flow channels are in fluid connection with each other. A periphery sealing member 360 seals a space between the ejection element substrate support member 230 and the frame body member 320 to suppress entering of the liquid. A back surface (a surface on an opposite side of the ejection port surface) of the ejection element substrate support member 230 may be sealed by a back surface sealing member 370 for reinforcement. As illustrated in FIG. 11, a hole into which the reference fixation member 350 is inserted opens in each of three portions in the support member 310. A configuration in which the reference fixation member 350 is fixed into the hole, and the reference member 340 is fixed into this reference fixation member 350 is applied. The reference fixation member 350 may be a member integral with the support member 310.

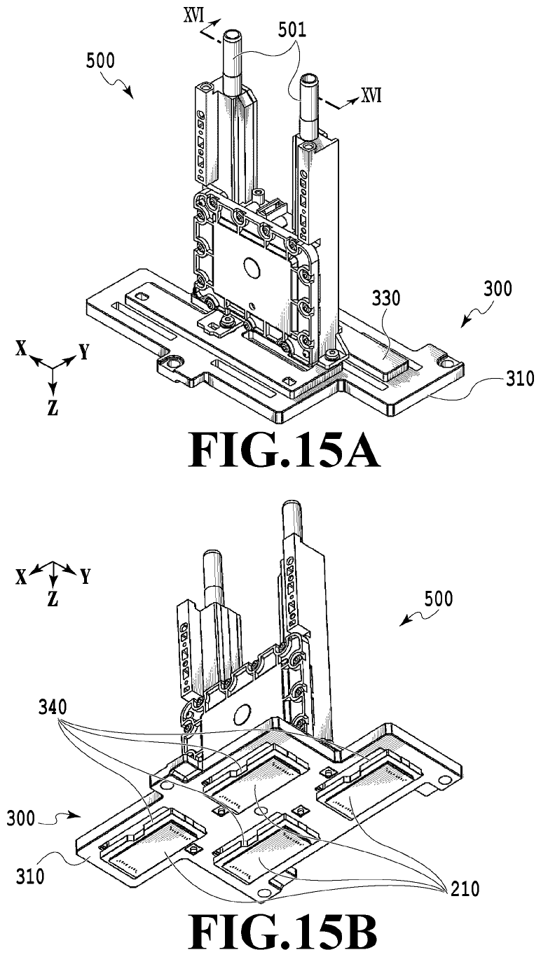

FIGS. 15A and 15B are diagrams illustrating a liquid member connection configuration between the support unit 300 and the liquid supply unit 500 of the liquid ejection head 100 according to the present embodiment. FIG. 15A is a perspective view that is viewed from above. FIG. 15B is a perspective view that is viewed from below. The liquid supply unit 500 includes the liquid connection unit 501 and is connected with the liquid supply unit 13 (FIG. 2) of the liquid ejection apparatus main body. Thus, a configuration in which the liquid is supplied from a supply system of the liquid ejection apparatus main body to the liquid ejection head 100, and additionally the liquid that passes through the liquid ejection head 100 is collected to the supply system of the liquid ejection apparatus main body is implemented. As described above, the liquid can be circulated through a path in the liquid ejection apparatus main body and a path in the liquid ejection head 100. A filter (not illustrated) communicating with each opening of the liquid connection unit 501 is provided inside the liquid supply unit 500 to remove a foreign substance in the ink to be supplied.

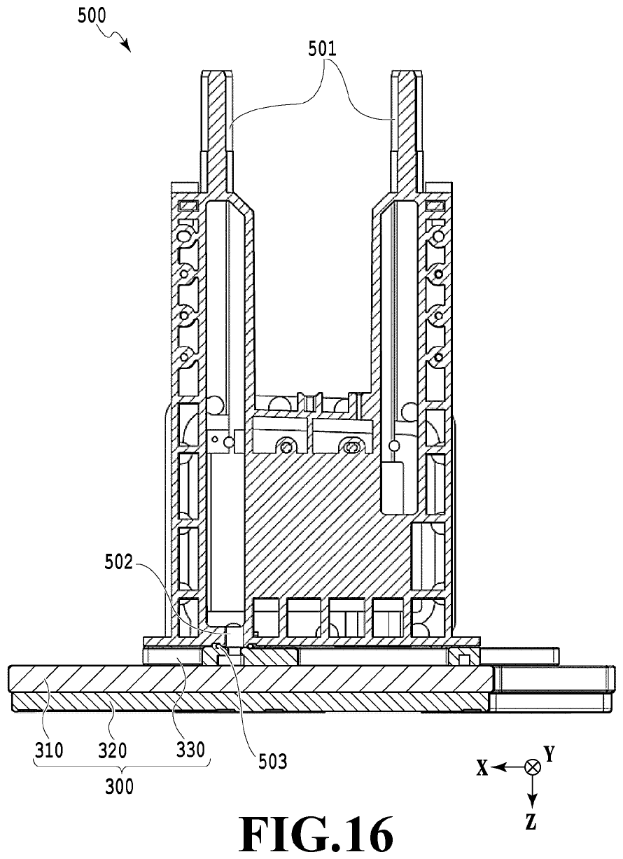

FIG. 16 is a cross-sectional view of a fluid connection unit between the liquid supply unit 500 and the liquid supply member 330. FIG. 16 is a cross-sectional view taken along XVI-XVI in FIG. 15A. The liquid that flows from the liquid ejection apparatus main body side through the liquid connection unit 501 passes through a communication port 502 and supplied to the liquid supply member 330. An elastic member 503 is in between the liquid supply unit 500 and the liquid supply member 330 for sealing.

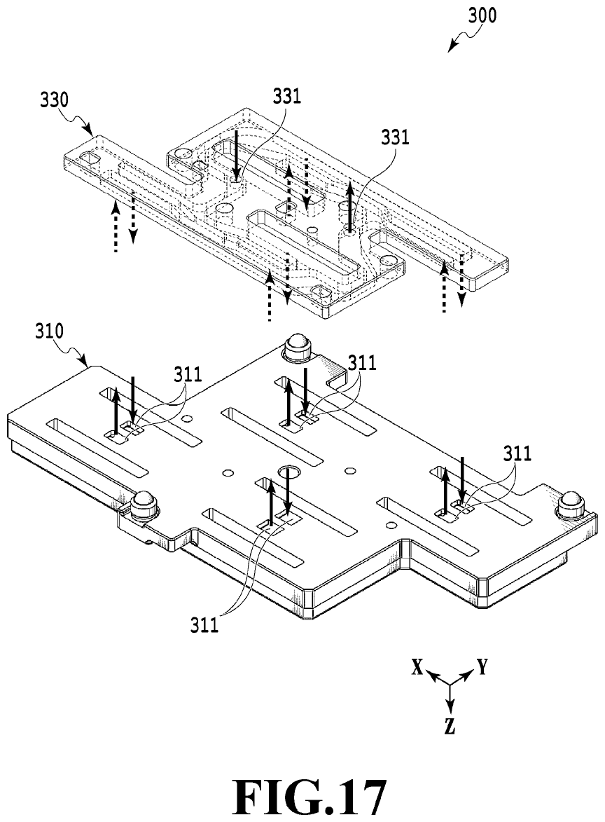

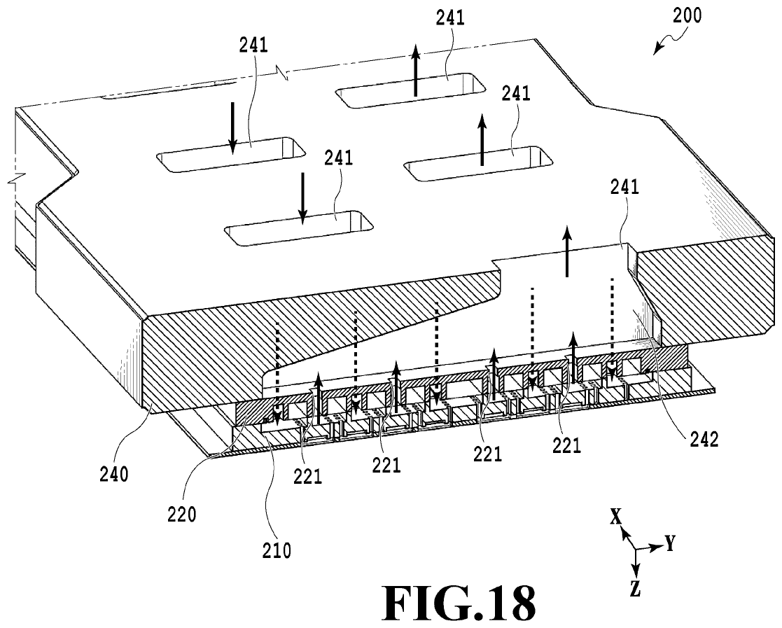

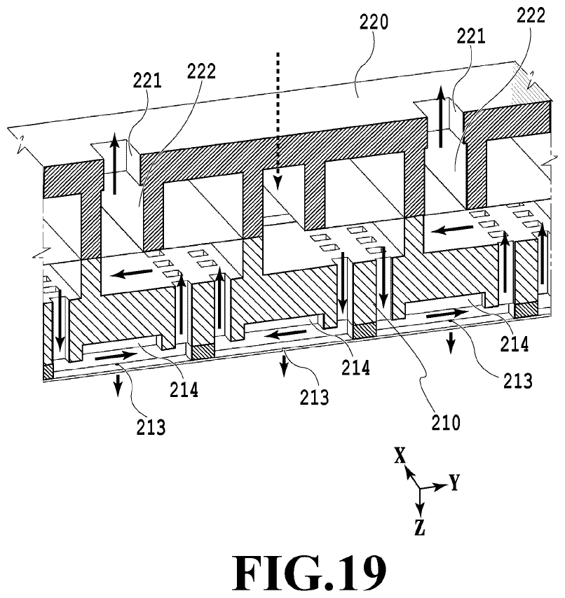

FIG. 17 is a diagram illustrating a liquid flow channel connection configuration of the support unit 300. FIG. 18 is a diagram illustrating a liquid flow channel connection configuration of the liquid ejection unit 200. The liquid supply unit 500 and the liquid supply member 330 in the support unit 300 are in fluid connection with each other through a first communication port 331. A flow channel to distribute the liquid to each liquid ejection unit 200 is formed in the liquid supply member 330. In the present example, flow channels to distribute the liquid to the four liquid ejection units 200 are formed in one liquid supply member 330. The liquid supply member 330 and the support member 310 are in fluid connection with each other through a second communication port 311. As illustrated in FIG. 18, the support member 310 and each liquid ejection unit 200 are in fluid connection with each other through a third communication port 241 in the flow channel member 240. A liquid flow channel 242 is formed in the flow channel member 240. The flow channel member 240 is in fluid connection with the ejection element substrate flow channel member 220 through a fourth communication port 221. FIG. 19 is a diagram illustrating a fluid connection configuration in the ejection element substrate 210. The liquid that flows from each fourth communication port 221 passes through a common flow channel 222 to be supplied to the ejection element substrate 210 and is ejected from an ejection port 213 by a piezoelectric element 214 that is the ejection element.

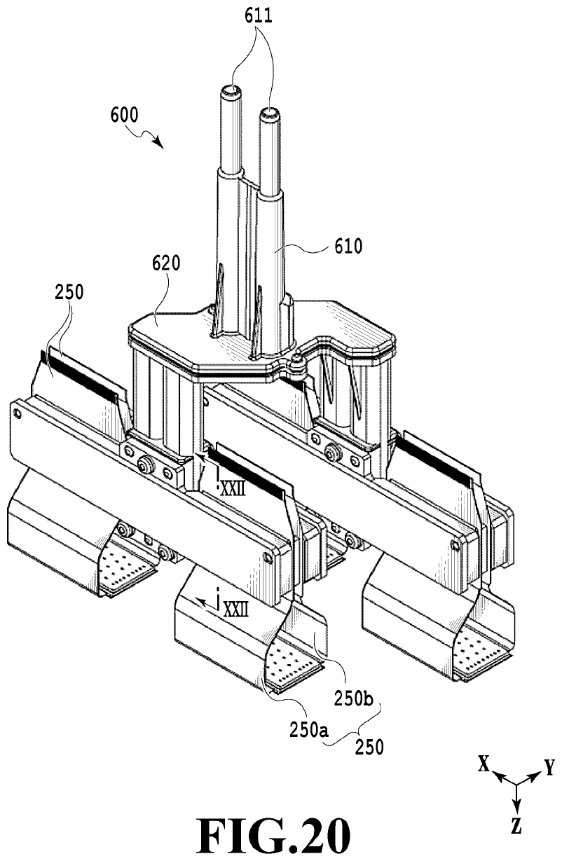

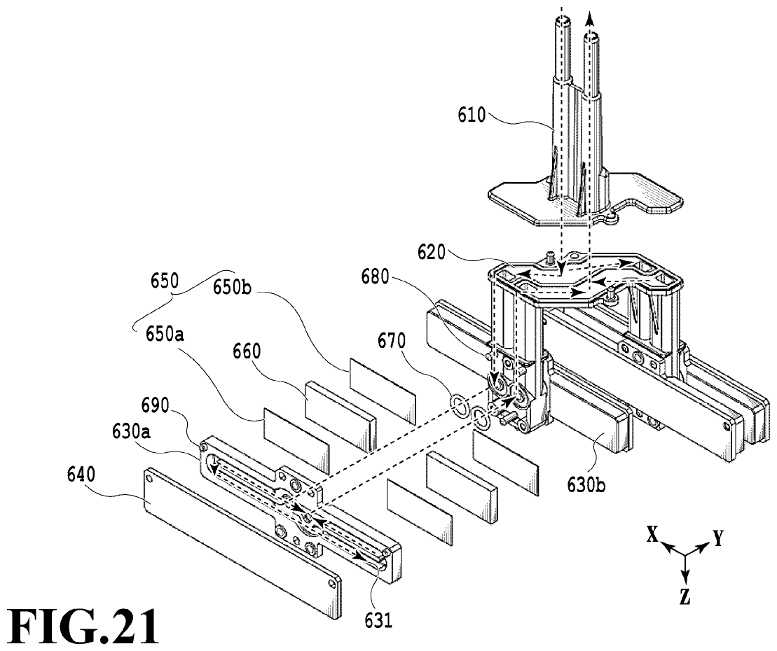

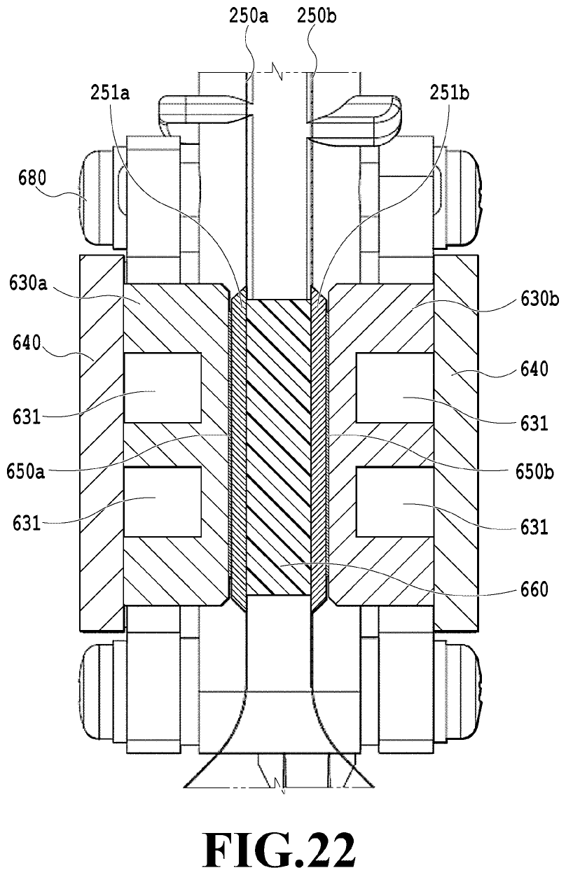

FIG. 20 is a perspective view of the cooling unit 600 to cool down the driving circuit substrate 251. FIG. 21 is an exploded view of the cooling unit 600. FIG. 22 is a cross-sectional view taken along XXII-XXII in FIG. 20. As described above, the driving circuit substrate 251 is arranged on the flexible wiring substrate 250 (see FIG. 5). FIG. 20 is a diagram of a state in which the driving circuit substrate 251 is covered with the cooling unit 600. As illustrated in FIG. 20, the cooling unit 600 includes the refrigerant connection unit 611. The refrigerant connection unit 611 is connected with the refrigerant supply unit 14 (FIG. 2) of the liquid ejection apparatus main body. Thus, a configuration in which the refrigerant is supplied from a refrigerant supply system of the liquid ejection apparatus main body to the cooling unit 600, and additionally the refrigerant that passes through the cooling unit 600 is collected to the refrigerant supply system of the liquid ejection apparatus main body is implemented. As described above, the refrigerant can be circulated through a path in the liquid ejection apparatus main body and a path in the cooling unit 600. As illustrated in FIG. 21, the refrigerant that flows from the refrigerant connection unit 611 is branched in a refrigerant flow channel formed between a first refrigerant supply member 610 and a second refrigerant supply member 620. The second refrigerant supply member 620 and a cooling member 630 are in fluid connection with each other through a sealing member 670. The refrigerant branched in the second refrigerant supply member 620 is circulated in a refrigerant flow channel 631 formed between the cooling member 630 and a lid member 640 and flows into the second refrigerant supply member 620 again. Then, the refrigerant that flows into the second refrigerant supply member 620 again converges in the refrigerant flow channel formed between the first refrigerant supply member 610 and the second refrigerant supply member 620 and flows out from the refrigerant connection unit 611. The second refrigerant supply member 620 and the cooling member 630 are fixed by a first fixation member 680. The cooling member 630 and the lid member 640 are fixed by a second fixation member 690.

The cooling unit 600 of the present embodiment includes four pairs of the cooling member 630 and the lid member 640. The second refrigerant supply member 620 is separated into two cooling systems in a Y direction. Each cooling system includes two sets of the pair of the cooling member 630 and the lid member 640. The two sets are provided so as to face each other in the Y direction. Additionally, a thermally conductive member 650 that is put in contact with the cooling member 630 is provided between the two sets in the Y direction.

Four cooling members 630 are provided in the cooling unit 600 of the present embodiment. In FIGS. 20 and 21, the cooling members 630 that are supplied with the refrigerant from the second refrigerant supply member 620 branched on a left front side of the paper surface are a first cooling member 630a and a second cooling member 630b in the order from the left front side of the paper surface. Note that, hereinafter, in a case where an individual cooling member is described, the cooling member is referred to as the first cooling member 630a and the second cooling member 630b, and in a case where a matter common to the two cooling members is described, the cooling members are simply described as the cooling member 630. Additionally, the thermally conductive member 650 that is put in contact with the first cooling member 630a is referred to as a first thermally conductive member 650a. The thermally conductive member 650 that is put in contact with the second cooling member 630b facing the first cooling member 630a is referred to as a second thermally conductive member 650b. Thus, the first cooling member 630a and the second cooling member 630b are arranged to face each other. As illustrated in FIG. 21, an elastic member 660 is arranged between the first thermally conductive member 650a and the second thermally conductive member 650b in the cooling unit 600. Note that, as illustrated in FIG. 20, the flexible wiring substrate 250 on which the driving circuit substrate 251 is arranged is provided between the thermally conductive member 650 and the elastic member 660, and the thermally conductive member 650 is put in contact with the driving circuit substrate 251 (see FIGS. 20 and 22). Additionally, the first cooling member 630a and the second cooling member 630b are each fixed by being pressed onto the second refrigerant supply member 620 by the first fixation member 680.

It is a configuration in which the cooling member 630 is put in contact with the driving circuit substrate 251 while the thermally conductive member 650 is sandwiched therebetween as described above, and thus the heat generated in an operation of the driving circuit substrate 251 is transferred to the refrigerant in the cooling member 630. It is preferable to select a member with a thermal conductivity as high as possible such as aluminum for example, for the cooling member 630 so as to facilitate the transference of the heat generated in the driving circuit substrate 251. The elastic member 660 is provided between the two flexible wiring substrates 250, and thus it is possible to closely put the thermally conductive member 650 in contact with the driving circuit substrate 251 reliably.

As illustrated in FIG. 20, two flexible wiring substrates 250 each including the driving circuit substrate 251 are arranged to extend from one ejection element substrate 210 in a −Z direction. The two flexible wiring substrates 250 are provided to face each other in a direction crossing the ejection port array direction in which the ejection ports 213 are formed. In more detail, the two flexible wiring substrates 250 are provided such that the driving circuit substrates 251 face outward from each other. In the flexible wiring substrate 250, the thermally conductive member 650 is put in contact with a side (an outer side) on which the driving circuit substrate 251 is arranged, and the elastic member 660 is put in contact with an opposite side (an inner side) of the side on which the driving circuit substrate 251 is arranged. Additionally, the cooling member 630 is put in contact with the driving circuit substrate 251 so as to sandwich the thermally conductive member 650 from an outer side of the thermally conductive member 650. That is, as illustrated in FIG. 22, in a facing direction in which the two flexible wiring substrates 250 face each other, the first cooling member 630a, the first driving circuit substrate 251a, the elastic member 660, the second driving circuit substrate 251b, and the second cooling member 630b are arranged in this order. Thus, it is possible to efficiently cool down the driving circuit substrate 251. As illustrated in FIG. 20, in the present embodiment, one cooling member 630 is formed to cool down the driving circuit substrates 251 of the multiple ejection element substrates 210.

The thermally conductive member 650 has a role in transferring the heat from the driving circuit substrate 251 to the cooling member 630. For this reason, it is preferable that the thermal resistance of the thermally conductive member 650 is small, and therefore it is preferable that the thickness of the thermally conductive member 650 is also thin. Additionally, it is preferable that the thermally conductive member 650 has elasticity so as to closely put the cooling member 630 and the driving circuit substrate 251 in contact with each other. It is preferable that the thickness of the thermally conductive member 650 is 8 mm or less. In the present embodiment, a heat dissipation sheet in which a filler is dispersed based on acrylic resin is arranged as the thermally conductive member 650, in which the thermal conductivity is 2 [W/mK], and the thickness is 1 mm.

In order to press the driving circuit substrate 251 onto the cooling member 630 reliably even in a case where the driving circuit substrate 251 is inclined or the like, it is preferable that the thickness of the elastic member 660 is at least greater than that of the thermally conductive member 650. In detail, it is preferable that the elasticity (strength in compression) of the elastic member 660 is about 0.01 [N/cm2] or more and 1.0 [N/cm2] or less.

In the present embodiment, the elastic member 660 to be used is formed of a foamed member based on ethylene propylene rubber (EPDM), in which the thickness is about 5 mm, and the strength in compression is about 0.18 [N/cm2].

Note that, the material of the elastic member 660 is not limited to the above-described EPDM, and may be a member based on rubber such as chlorinated butyl rubber or urethan rubber, or silicone or elastomer, for example.

Additionally, the thermally conductive member 650 is also not limited to the above-described thermally conductive sheet. The thermally conductive member 650 may not be a member in the form of a sheet but thermally conductive grease in the form of a paste. Moreover, although it is preferable that the thermally conductive member 650 is provided as mentioned above, a configuration in which no thermally conductive member 650 is provided may be applicable.

The heating from the driving circuit substrate 251 in the present embodiment is about 17 W. The four ejection element substrates 210 are on board the one liquid ejection head 100 (note that, as illustrated in FIG. 1, eight liquid ejection heads 100 are on board the liquid ejection apparatus 10). The two flexible wiring substrates 250 from the one ejection element substrate 210 are connected to the electric wiring substrate 400, and the driving circuit substrate 251 is on board each flexible wiring substrate 250. Accordingly, eight driving circuit substrates 251 in total are on board the liquid ejection head 100 of the present embodiment. The temperature of the refrigerant in a case where the refrigerant of the cooling unit 600 is put into the head is 30° C., and the flow rate for each driving circuit substrate 251 can be about 8 cc/min or more and 30 cc/min or less. That is, the flow rate of the refrigerant that flows through the refrigerant connection unit 611 in the overall liquid ejection head 100 is controlled to be about 64 cc/min or more and 240 cc/min or less. Accordingly, the temperature of the driving circuit substrate 251 is maintained at 80° C. or less, or more preferably, 60° C. or less.

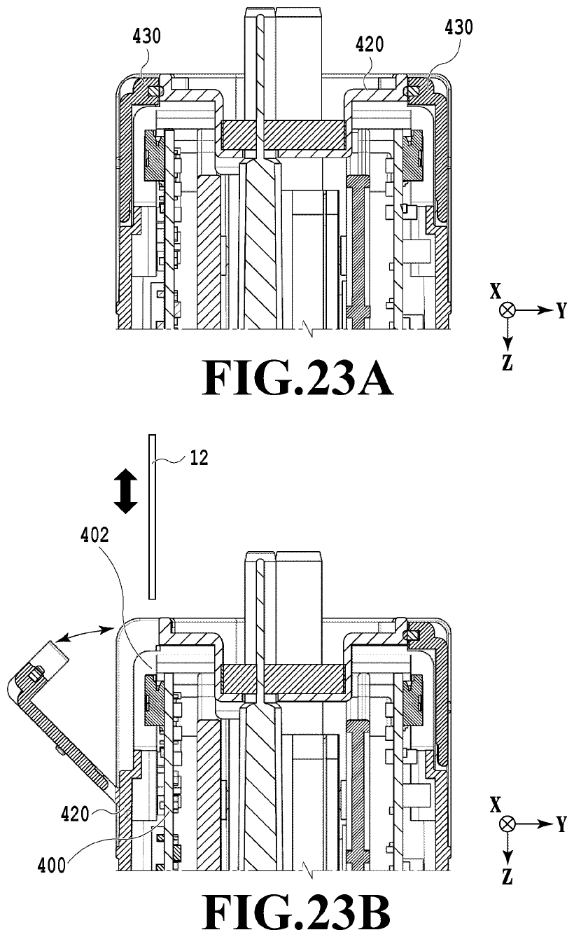

FIGS. 23A and 23B are diagrams illustrating a cross-sectional view of an electric connection unit between the liquid ejection apparatus main body and the liquid ejection head 100. The electric wiring substrate 400 in the liquid ejection head 100 includes the electric connection terminal 402. The connection of the electric connection terminal 402 with a liquid ejection apparatus electric wiring unit 12 implements the electric connection between the liquid ejection apparatus 10 and the liquid ejection head 100. It is a configuration in which a periphery of the electric connection terminal 402 is covered with the openable and closable electric connection unit cover member 430.

As described above, according to the present embodiment, it is possible to efficiently cool down the driving circuit substrate 251 including the driving element. That is, in the present embodiment, even in a case where the size of the driving circuit substrate 251 is large, it is possible to put the cooling member 630 in contact with the driving circuit substrate 251 reliably and to cool down the driving circuit substrate 251 efficiently without increasing the size of the liquid ejection head 100. Additionally, in the present embodiment, the facing cooling members 630 are fixed so as to sandwich and press the driving circuit substrate 251. Therefore, it is possible to secure thermal contact between the driving circuit substrate 251 and the cooling members 630 without additionally providing a support member to support the driving circuit substrate 251.

### Second Embodiment

In the first embodiment, an example in which the elastic member 660 is arranged between the first thermally conductive member 650a and the second thermally conductive member 650b in the cooling unit 600 is described. In the present embodiment, a mode in which no elastic member 660 is arranged is described. Since the basic configuration is similar to that of the example described in the first embodiment, a different point is mainly described.

In the present embodiment, an example in which the cooling member 630 is closely put in contact with the driving circuit substrate 251 while sandwiching the thermally conductive member 650 without providing the elastic member 660 is described. In the present embodiment, a head of the same size as that of the liquid ejection head 100 described in the first embodiment is used. For this reason, in the present embodiment, the thickness (the width in the Y direction) of the cooling member 630 is formed greater than that in the first embodiment. In other words, the thickness of the cooling member 630 is formed greater to fill a space in which the elastic member 660 is arranged in the first embodiment. Additionally, since no elastic member 660 is arranged, the facing flexible wiring substrates 250 are put in contact with each other in the present embodiment.

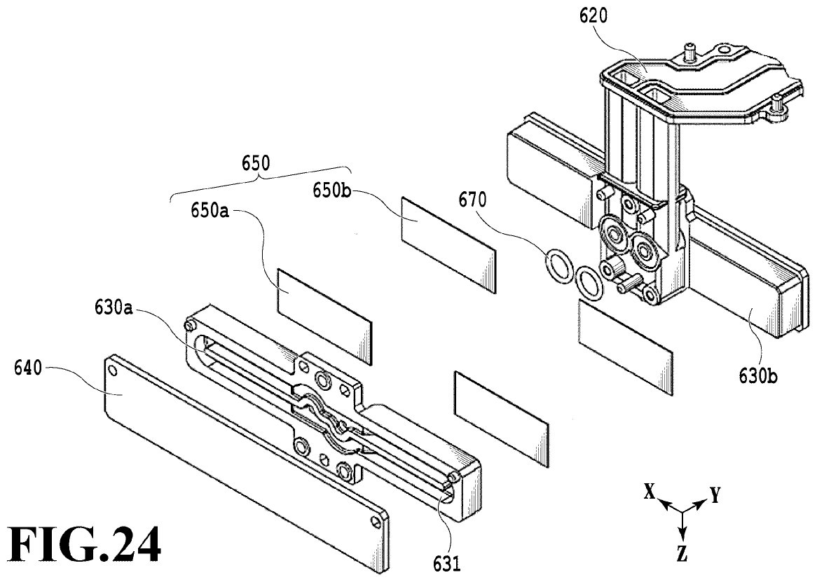

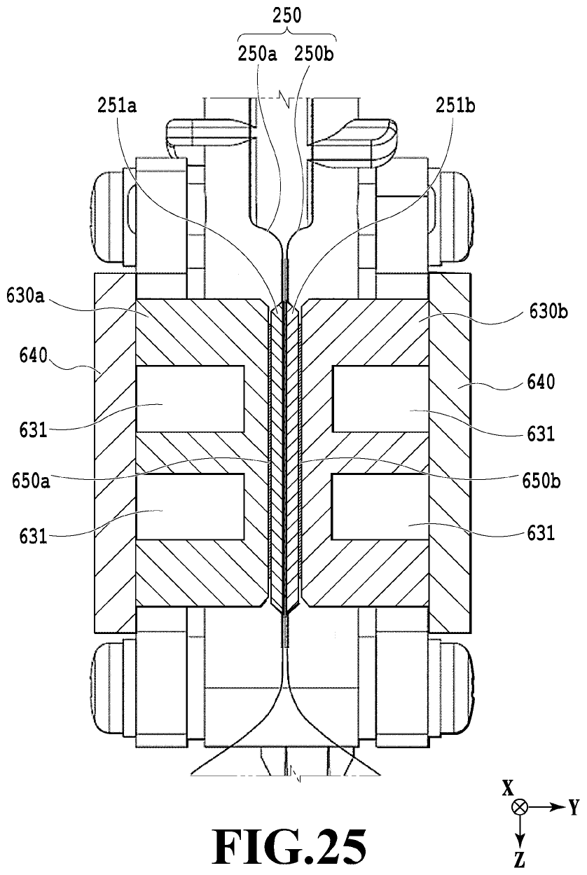

FIG. 24 is an exploded view of the cooling unit 600. FIG. 24 is a diagram corresponding to FIG. 21 in the first embodiment. FIG. 25 is a cross-sectional view of the cooling unit 600. FIG. 25 is a diagram corresponding to FIG. 22 in the first embodiment and is a diagram corresponding to the cross-sectional view taken along XXII-XXII in FIG. 20 in the first embodiment. In the present embodiment, as illustrated in FIG. 25, the facing flexible wiring substrates 250 are put in contact with each other. Additionally, the two facing cooling members 630 are fixed on the second refrigerant supply member 620 in a structure of sandwiching the driving circuit substrate 251. As illustrated in FIG. 25, the facing cooling members 630 are fixed on the second refrigerant supply member 620 so as to push the driving circuit substrate 251 onto each other. In the above-described configuration, it is also possible to secure the thermal contact between the driving circuit substrate 251 and the cooling member 630 without additionally providing a support member to support the driving circuit substrate 251.

### Other Embodiments

In the above-mentioned embodiments, an example in which the driving circuit substrates 251 of the different liquid ejection units 200 are cooled down in one cooling member 630 is described. That is, an example in which the driving circuit substrates 251 of the two liquid ejection units 200 are cooled down by the two facing cooling members is described. However, it is not limited to this example. One cooling member 630 may be formed to cool down the driving circuit substrate 251 of one liquid ejection unit 200. Alternatively, one cooling member 630 may be formed to cool down the driving circuit substrates 251 of three or more liquid ejection units 200.

Additionally, in the above-mentioned example, an example in which the flexible wiring substrate with a high degree of freedom of the layout is used is described; however, a mode in which no flexible wiring substrate is used may be applicable. In this case, any configuration may be applicable as long as it is possible to cool down the driving element by using the cooling member 630 for the driving circuit substrate 251.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-207546, filed Dec. 23, 2022, which is hereby incorporated by reference wherein in its entirety.

What is claimed is:

1. A liquid ejection head, comprising:
a liquid ejection unit including
an ejection element substrate in which a plurality of ejection ports configured to eject a liquid are arrayed in an array direction and including a plurality of ejection elements configured to generate energy to eject the liquid from the ejection ports,
a first wiring substrate and a second wiring substrate connected with the ejection element substrate and arranged to face each other so as to sandwich the ejection element substrate from a facing direction substantially orthogonal to the array direction,
a first driving element provided on the first wiring substrate and configured to drive the ejection elements,
a second driving element provided on the second wiring substrate and configured to drive the ejection elements,
a first cooling member configured to cool down the first driving element, and
a second cooling member configured to cool down the second driving element, wherein
in the facing direction, the first cooling member, the first driving element, the second driving element, and the second cooling member are arranged in this order.

2. The liquid ejection head according to claim 1, wherein
the first cooling member is fixed so as to press the first driving element in the facing direction, and the second cooling member is fixed so as to press the second driving element in the facing direction.

3. The liquid ejection head according to claim 1, further comprising:
a refrigerant supply member configured to supply a refrigerant to each of the first cooling member and the second cooling member, wherein
the first cooling member and the second cooling member are fixed on the refrigerant supply member.

4. The liquid ejection head according to claim 1, wherein
in the facing direction, an elastic member is arranged between the first driving element and the second driving element.

5. The liquid ejection head according to claim 1, wherein
in the facing direction, a first thermally conductive member is provided between the first cooling member and the first driving element, and a second thermally conductive member is provided between the second cooling member and the second driving element.

6. The liquid ejection head according to claim 5, wherein
in the facing direction, an elastic member is arranged between the first driving element and the second driving element.

7. The liquid ejection head according to claim 6, wherein
a thickness of the elastic member in the facing direction is thicker than a thickness of each of the first thermally conductive member and the second thermally conductive member.

8. The liquid ejection head according to claim 1, comprising:
a plurality of the liquid ejection units.

9. The liquid ejection head according to claim 8, wherein
the first cooling member is in contact with the first driving elements of the two or more liquid ejection units.

10. The liquid ejection head according to claim 8, wherein
the second cooling member is in contact with the second driving elements of the two or more liquid ejection units.

11. The liquid ejection head according to claim 8, wherein
the plurality of the liquid ejection units are arrayed in a staggered pattern.

12. The liquid ejection head according to claim 11, wherein
the first cooling member and the second cooling member cool down the plurality of the liquid ejection units in one array out of the plurality of the liquid ejection units arrayed in a staggered pattern.

13. The liquid ejection head according to claim 1, wherein
the first cooling member and the second cooling member cool down the first driving element and the second driving element by a refrigerant supplied from a liquid ejection apparatus including the liquid ejection head on board.

14. A liquid ejection apparatus, comprising:
a liquid ejection head including a liquid ejection unit including
an ejection element substrate in which a plurality of ejection ports configured to eject a liquid are arrayed in an array direction and including a plurality of ejection elements configured to generate energy to eject the liquid from the ejection ports,
a first wiring substrate and a second wiring substrate connected with the ejection element substrate and arranged to face each other so as to sandwich the ejection element substrate from a facing direction substantially orthogonal to the array direction,
a first driving element provided on the first wiring substrate and configured to drive the ejection elements,
a second driving element provided on the second wiring substrate and configured to drive the ejection elements,
a first cooling member configured to cool down the first driving element, and
a second cooling member configured to cool down the second driving element, wherein
in the facing direction, the first cooling member, the first driving element, the second driving element, and the second cooling member are arranged in this order;
a liquid supply unit configured to supply the liquid to the liquid ejection head; and
a refrigerant supply unit configured to supply a refrigerant to the liquid ejection head.
